(19) United States
(12) Patent Application Publication
(10) Pub. No.: US 2012/0076888 A1
(43) Pub. Date: Mar. 29, 2012

(54) MOULD WITH THE CONTACT PREPRESSING AND POSITIONING FUNCTION

(75) Inventors: Xiao-ping Wu, Tu Cheng (TW); Shih-hsiung Ho, Tu Cheng (TW); Kun-hsueh Chiang, Tu Cheng (TW)

(73) Assignee: Cheng Uei Precision Industry Co., LTD., Tu Cheng City (TW)

(21) Appl. No.: 12/892,792

(22) Filed: Sep. 28, 2010

(51) Int. Cl. B29C 45/26

(52) U.S. Cl. 425/542

(57) ABSTRACT

Provided is a mould with the contact prepressing and positioning function, including a core insert member and a cavity insert member. The core insert member disposes a positioning post. The cavity insert member disposes a positioning dowel and a spring member. An upper end of the spring member is fixedly connected to the cavity insert member. An upper end of the positioning dowel is connected to the lower end of the spring member and is slideably received in the cavity insert member by the spring member, and a lower end of the positioning dowel is protruding out of the cavity insert member and has a hollow structure provided for the positioning post being inserted therein. The mould of the prevent invention can effectively avoid the contact warping generated by the free elastic force of the contacts thereby protecting the mould, improving the yield rate and reducing the manufacture cost.

### BACKGROUND OF THE INVENTION

1. Field of the Invention

The present invention relates to a mould for insert molding a contact housing, and more particularly to a mould with the contact prepressing and positioning function.

2. Description of the Prior Art

As everyone knows, prior method for manufacturing an electrical connector generally adopts an insert assembling process or an insert-molding process.

Generally, the insert assembling process is placing a row of contacts on a predetermined position of an insulating housing of the electrical connector, and applying the force on the tails of the contacts for pushing the contacts into the insulating housing and making them combine together. However, this insert assembling process obviously affects the mechanical and electrical performance of the electrical connector.

The insert-molding process can avoid the above defects of the insert assembling process and can be completed by a special contact-insert-molding machine. The prior contact-insert-molding machine includes a core insert member and a cavity insert member, which are corresponding to each other. During the insert-molding process, a material tape with the contacts is placed between the core insert member and the cavity insert member, and then the insulating housing is molded on a predetermined position of the material tape of the contacts and is integrally combined with the contacts, so that obtaining a combination body of the contacts and the insulating housing and being convenient to be assembled with other components of the electrical connector.

But in the insert-molding process of employing the prior contact-insert-molding machine, when the material tape with the contacts is placed in the mould, the contacts may be detached from the mould because of warping of the contacts. As a result, the position of the contacts in the insulting housing may not be qualified, and the electrical connector including the contacts and the insulting housing molded together may not be successfully connected to a corresponding connector. Moreover, the components of the mould are easily damaged because of warping or tilting of the contacts.

### BRIEF SUMMARY OF THE INVENTION

An object of the present invention is to provide a mould with the contact prepressing and positioning function, which can prepress the contact to avoid the contact warping generated by the free elastic force of the contact for protecting the mould, improving the yield rate and reducing the manufacture cost.

To achieve the above object, in accordance with the present invention, a mould with the contact prepressing and positioning function is provided, comprising: a core insert member and a cavity insert member, which are corresponding to each other. The core insert member disposes a positioning post. The cavity insert member disposes a positioning dowel and a spring member, which are straightly facing to the positioning post of the core insert member. An upper end of the spring member is fixedly connected to the cavity insert member. An upper end of the positioning dowel is connected to the lower end of the spring member and is slideably received in the cavity insert member by the aid of the spring member, and a lower end of the positioning dowel is protruding out of the cavity insert member and has a hollow structure provided for the positioning post being inserted therein.

Based on the above description, a mould with the contact prepressing and positioning function, as provided by the present invention, employs the core insert member having the positioning post and the cavity insert member having the positioning dowel corresponding to the positioning post in the present invention. Before the core insert member and the cavity insert member are completely closed, the positioning post is gradually engaged with the positioning post for positioning the contacts. The insert-molding process cannot be started until the core insert member and the cavity insert member are completely closed. Therefore, the mould of the prevent invention can effectively avoid the contact warping generated by the free elastic force of the contacts thereby protecting the mould, improving the yield rate and reducing the manufacture cost.

### BRIEF DESCRIPTION OF THE DRAWINGS

FIG. 1 is a perspective view of a mould with the contact prepressing and positioning function according to one embodiment of the present invention;

FIG. 2 is a plane view of the mould in FIG. 1;

FIG. 3 is a sectional view of the mould, taken along a line A-A of FIG. 2;

FIG. 4 is a sectional view illustrating a contact prepressing state of the mould before being completely closed;

FIG. 5 is a sectional view of the mould being completely closed; and

FIG. 6 is a schematic view of a product molded by the mould after insert molding.

### DETAILED DESCRIPTION OF THE PREFERRED EMBODIMENTS

The following embodiment with reference to the accompanying drawings now has been given for detail describing the technology, the feature, the object and the effect of the present invention.

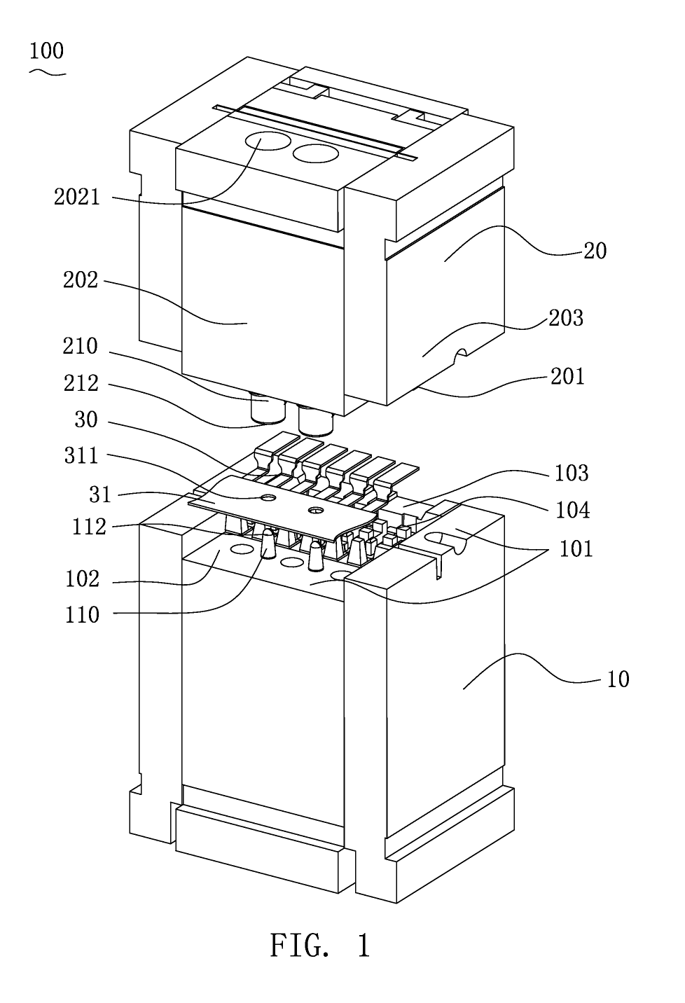

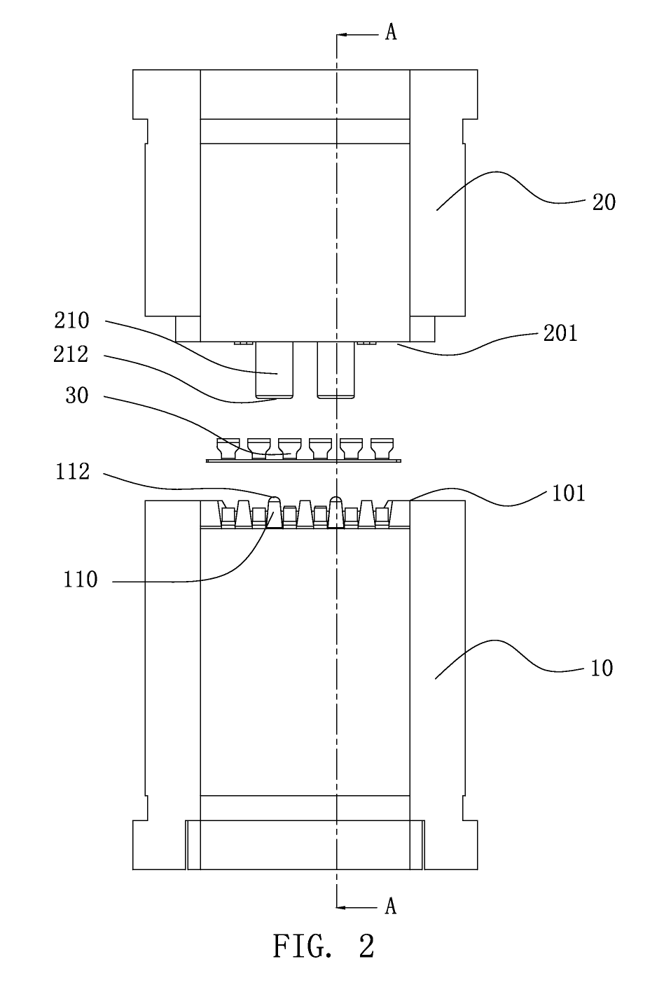

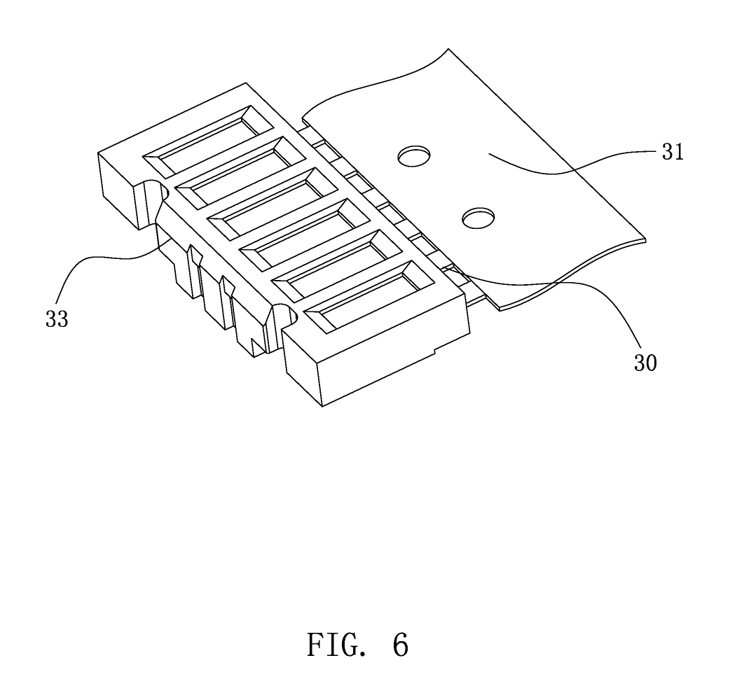

Please refer to FIGS. 1 to 3, which show a preferred embodiment of a mould 100 of the present invention. In this embodiment, the mould 100 is mounted on an insert-molding machine for producing a contact housing 33 (as shown in FIG. 6), which is molded with contacts 30 carried by a material tape 31 with at least one positioning hole 311. The mould 100 comprises a core insert member 10 and a cavity insert member 20, which are corresponding to each other. The core insert member 10 is mounted on a movable stage (not shown in all FIGS) of the insert-molding machine, and the cavity insert member 20 is mounted on a fixed stage (not shown in all FIGS).

The core insert member 10 includes a lower positioning section 102 and a lower molding section 103, which are integrally formed together. The lower positioning section 102 disposes at least one positioning post 110, which is straightly facing to the positioning hole 311 of the material tape 31 and has a longitudinal columnar shape. A fixing end 111 of the positioning post 110 is embedded in the lower positioning section 102 and is fixedly connected to a bottom of the lower positioning section 102. A protruding end 112 of the positioning post 110, which is away from the fixing end 111, is protruding out of a top surface 101 of the core insert member 10. The lower molding section 103 defines a lower cavity 104.

Correspondingly, the cavity insert member 20 includes an upper positioning section 202 and an upper molding section 203, which are integrally formed together. The upper positioning section 202 is straightly facing to the lower positioning section 102, and the upper molding section 203 is straightly facing to the lower molding section 103. A bottom surface 201 is straightly facing to the top surface 101 of the core insert member 10. When the core insert member 10 and the cavity insert member 20 are completely closed, the bottom surface 201 of the cavity insert member 20 is contacted with the top surface 101 of the core insert member 10. The upper positioning section 202 disposes a sliding hole 2021 passing through the top and bottom surfaces thereof and straightly facing to the positioning post 110 of the lower positioning section 102. The sliding hole 2021 disposes a shoulder 2022 on an inner side thereof, so that the sliding hole 2021 is wide in an upper end and narrow in a lower end. The upper positioning section 202 also disposes a positioning dowel 210 and a spring member 220, which are straightly facing to the positioning post 110 of the lower positioning section 102. An upper end 222 of the spring member is connected to the bottom (not shown in all FIGS) of the cavity insert member 20, and a lower end 221 of the spring member 220 is connected to the positioning dowel 210.

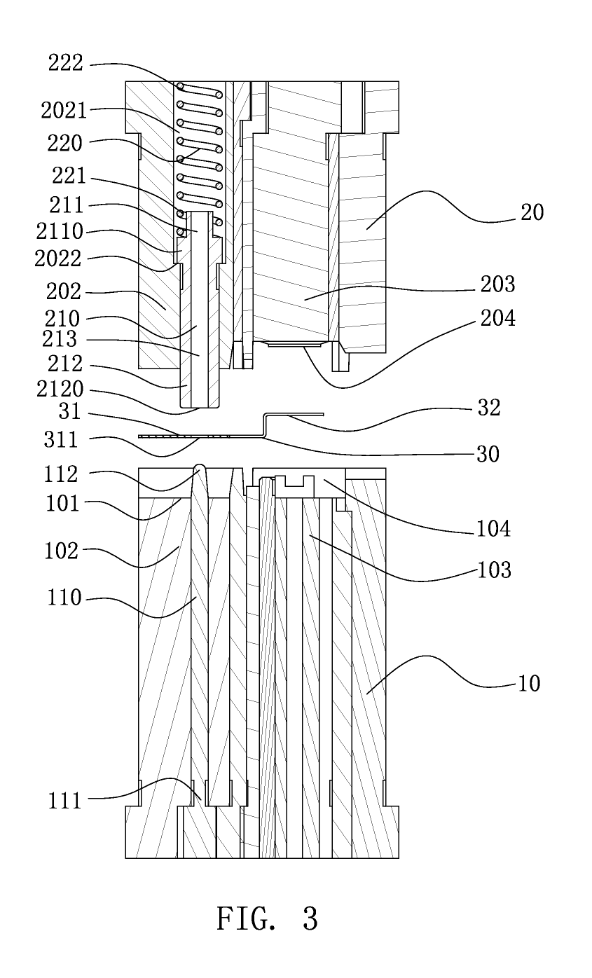

Referring to FIG. 3, a connecting end 211 of the positioning dowel 210 is connected to the lower end 221 of the spring member 220 and is slideably received in the sliding hole 2021. A protruding end 212 of the positioning dowel 210, which is away from the connecting end 211, is protruding out of the bottom surface 201 of the cavity insert member 20 and engages with the positioning post 110 of the upper positioning section 101. An end surface 2120 of the protruding end 212 of the positioning dowel 210 is perpendicular to the length direction of the positioning dowel 210 for tightly pressing the material tape 31 of the contacts 30 onto the top surface 101 of the core insert member 10. The positioning dowel 210 has a hollow structure and forms a dowel hole 213 in the center thereof. The dowel hole 213 is provided for receiving the positioning post 110 of the core insert member 10. The positioning dowel 210 disposes a limiting block 2110 being adjacent to the connecting end 211 and projecting outward. During the sliding of the positioning dowel 210, the limiting block 2110 is supported by the shoulder 2022, so that the connecting end 211 of the positioning dowel 210 is always received in the sliding hole 2021.

The upper molding section 203 defines an upper cavity 204 on the bottom surface 201 of the cavity insert member 20. When the core insert member 10 and the cavity insert member 20 are completely closed, the upper cavity 204 together with the lower cavity 104 forms a mould cavity, which is an area for molding a product, namely is an area of a finished product.

It need be noted that the number of the positioning post 110, the sliding hole 2021, the positioning dowel 210 and the spring member 220 of the present mould 100 can be set according to the size of the mould cavity. In this embodiment, the number thereof is two.

Referring to FIGS. 3 to 6, the work process of the present mould 100 will be specifically described.

First, as shown in FIG. 3, when the core insert member 10 and the cavity insert member 20 are in an opened state, the contacts 30 waiting to be molded are placed between the core insert member 10 and the cavity insert member 20 by a holding member (not shown in all FIGS), the material tape 31 of the contacts 30 is placed between the lower positioning section 102 and the upper positioning section 202, and insert-molding portions 32 of the contacts 30 are placed between the lower cavity 104 and the upper cavity 204. Now, the positioning hole 311 of the material tape 31 of the contacts 30 are straightly facing to the positioning post 110 of the core insert member 10.

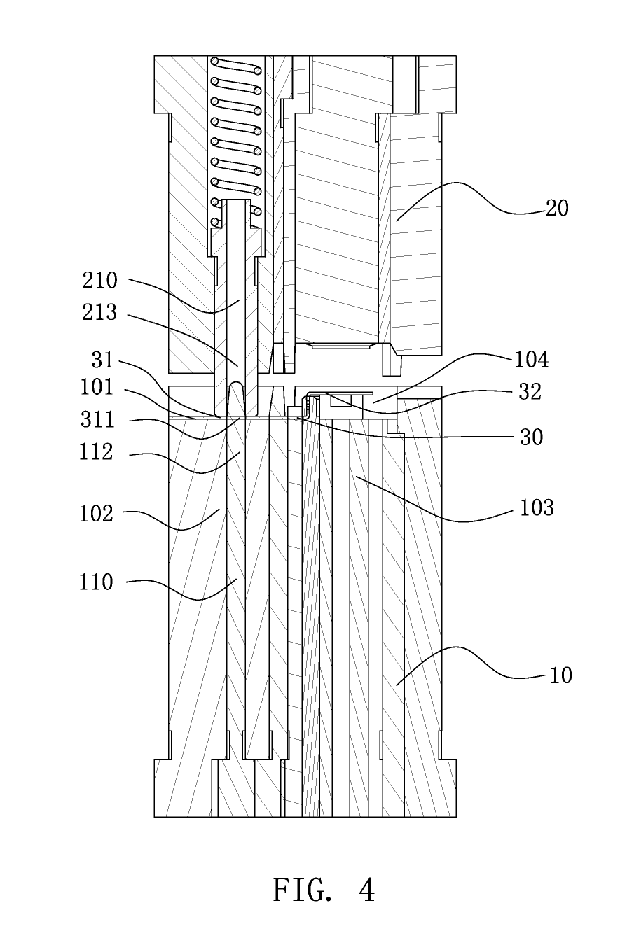

Secondly, as shown in FIG. 4, it shows a contact prepressing state of the mould before being completely closed. Under the function of the movable stage of the insert-molding machine, the core insert member 10 moves toward the cavity insert member 20, the protruding end 112 of the positioning post 110 on the core insert member 10 passes through one corresponding positioning hole 311 of the material tape 31 and then is inserted into the dowel hole 213 of the positioning dowel 210 on the cavity insert member 20. Now, the contacts can be rightly positioned by engagement of the positioning dowel 210 with the positioning post 110, so that the material tape 31 with the positioning hole 311 can be pressed on the top surface 101 of the lower positioning section 102, and the insert-molding portions 32 of the contacts 30 also can be pressed close to the lower cavity 104 of the lower molding section 103.

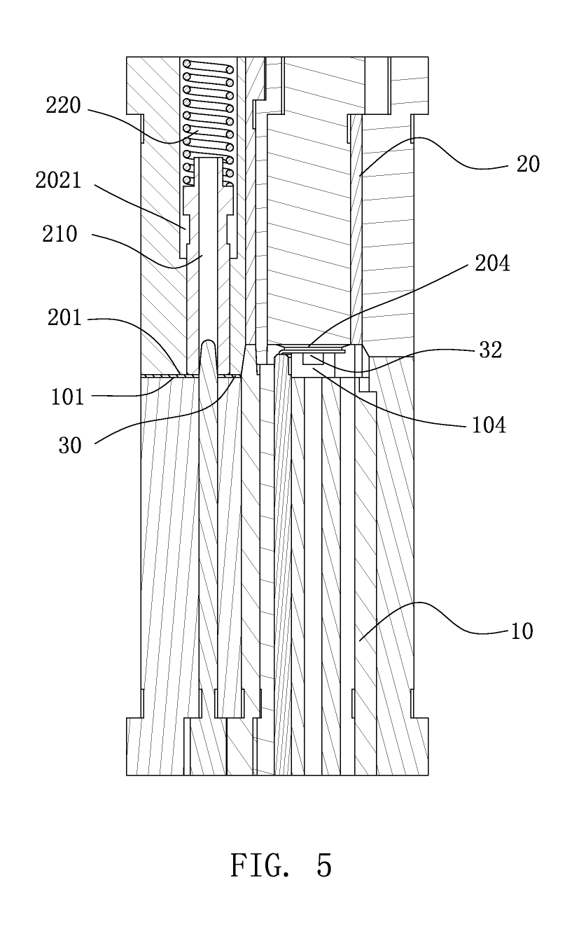

Then, please refer to FIG. 5, after the contacts 30 are positioned, the core insert member 10 continues to move toward the cavity insert member 20 under the function of the movable stage of the insert-molding machine. The positioning dowel 210 of the cavity insert member 20 can be driven by the core insert member 10 to slide upward in the sliding hole 2021 and to compress the spring member 220. When the protruding end 212 of the positioning dowel 210 completely enters into the sliding hole 2021 of the cavity inert 20, the top surface 101 of the core insert member 10 is contacted with the bottom surface 201 of the cavity insert member 20, and the mould cavity is defined between the lower cavity 104 and the upper cavity 201 and is used as the area of the finish product. The plastic material is injected into the mould cavity for being molded to the contact housing 33 on the insert-molding portions 32 of the contacts 30. Now, the core insert member 10 and the cavity insert member 20 are completely in a closed state. Next, the process of insert molding, cooling, opening the mould 100 and ejecting the finished product can be continuously performed. The finished product after insert molding is shown in FIG. 6, and includes the material tape 31 of the contacts 30 and the contact housing 33 integrally molded together with the contacts 30.

As described above, the mould 100 with the contact prepressing and positioning function employs the core insert member 10 having the positioning post 110 and the cavity insert member 20 having the positioning dowel 210 corresponding to the positioning post 110 in the present invention. Before the core insert member 10 and the cavity insert member 20 are completely closed, the positioning post 210 is gradually engaged with the positioning post 110 for positioning the contacts 30. The insert-molding process cannot be started until the core insert member 10 and the cavity insert member 20 are completely closed. Therefore, the mould 100 of the prevent invention can effectively avoid the contact warping generated by the free elastic force of the contacts 30 thereby protecting the mould 100, improving the yield rate and reducing the manufacture cost.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A mould with a contact prepressing and positioning function comprising:
a core insert member and a cavity insert member, which are corresponding to each other;
wherein the core insert member disposes a positioning post; the cavity insert member disposes a positioning dowel and a spring member, which are straightly facing to the positioning post of the core insert member; an upper end of the spring member is fixedly connected to the cavity insert member;
an upper end of the positioning dowel is connected to the lower end of the spring member and is slideably received in the cavity insert member by the aid of the spring member, and a lower end of the positioning dowel is protruding out of the cavity insert member and has a hollow structure provided for the positioning post being inserted therein.

2. The mould with the contact prepressing and positioning function as claimed in claim 1, wherein an end surface of the lower end of the positioning dowel is perpendicular to the length direction of the positioning dowel.

3. The mould with the contact prepressing and positioning function as claimed in claim 1, wherein the cavity insert member disposes a sliding hole passing through thereof and straightly facing to the positioning post, and the positioning dowel is slideably mounted in the sliding hole.

4. The mould with the contact prepressing and positioning function as claimed in claim 3, wherein the positioning dowel disposes a limiting block protruding from the upper end, and the sliding hole has a shoulder for supporting the limiting block.
